(19) United States
(12) Patent Application Publication
(10) Pub. No.: US 2026/0106657 A1
(43) Pub. Date: Apr. 16, 2026

(54) DIGITAL PREDISTORTION (DPD) WITH ADAPTIVE BEAM WEIGHTS

(71) Applicant: QUALCOMM Incorporated, San Diego, CA (US)

(72) Inventors: Vasanthan RAGHAVAN, West Windsor Township, NJ (US); Igor GUTMAN, Hod HaSharon (IL); Tao LUO, San Diego, CA (US)

(21) Appl. No.: 18/913,620

(22) Filed: Oct. 11, 2024

(51) Int. Cl. H04B 7/06; H04B 17/318; H04L 25/02

(52) U.S. Cl. CPC H04B 7/0639; H04B 7/0617; H04B 17/328; H04L 25/0212

(57) ABSTRACT

Certain aspects of the present disclosure are directed towards a method for wireless communications at a first device. The method generally includes: transmitting training signals using a subset of beam weights; receiving feedback signaling based on the training signals; and transmitting a communication signal with digital pre-distortion (DPD) using DPD coefficients determined based on the feedback signaling.

### TECHNICAL FIELD

Certain aspects of the present disclosure generally relate to wireless communication and, more particularly, to techniques for digital predistortion (DPD) with adaptive beam weights.

### BACKGROUND

Wireless communication devices are widely deployed to provide various communication services such as telephony, video, data, messaging, broadcasts, and so on. Such wireless communication devices may transmit and/or receive radio frequency (RF) signals via any of various suitable radio access technologies (RATs) including, but not limited to, Fifth Generation (5G) New Radio (NR), Long Term Evolution (LTE), Code Division Multiple Access (CDMA), Time Division Multiple Access (TDMA), Wideband CDMA (WCDMA), Global System for Mobility (GSM), Bluetooth, Bluetooth Low Energy (BLE), ZigBee, wireless local area network (WLAN) RATs (e.g., WiFi), and the like.

A wireless communication network may include a number of base stations that can support communication for a number of mobile stations. A mobile station (MS) may communicate with a base station (BS) via a downlink and an uplink. The downlink (or forward link) refers to the communication link from the base station to the mobile station, and the uplink (or reverse link) refers to the communication link from the mobile station to the base station. A base station may transmit data and control information on the downlink to a mobile station and/or may receive data and control information on the uplink from the mobile station. The base station and/or mobile station may include a radio implemented with a transceiver that may include a power amplifier (PA) for signal amplification.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description,” one will understand how the features of this disclosure provide the advantages described herein.

Certain aspects of the present disclosure are directed towards a method for wireless communications at a first device. The method generally includes: transmitting training signals using a subset of beam weights; receiving feedback signaling based on the training signals; and transmitting a communication signal with digital pre-distortion (DPD) using DPD coefficients determined based on the feedback signaling.

Certain aspects of the present disclosure are directed towards a method for wireless communications at a first device. The method generally includes: receiving an indication to assist DPD training for a second device; receiving training signals from the second device, wherein the training signals are transmitted using a subset of beam weights available for adaptive beamforming; and transmitting feedback signaling based on the training signals.

Certain aspects of the present disclosure are directed towards a method for wireless communications at a base station. The method generally includes: receiving an indication that a first device is activating an adaptive beam weight feature; and taking one or more actions to assist the first device to perform DPD training for a subset of beam weights available for adaptive beamforming in response to the indication.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a diagram of an example wireless communications network, in which aspects of the present disclosure may be practiced.

FIG. 2 is a block diagram conceptually illustrating a design of an example base station (BS) and user equipment (UE), in which aspects of the present disclosure may be practiced.

FIG. 3 is a block diagram of an example radio frequency (RF) transceiver, in which aspects of the present disclosure may be practiced.

FIG. 4 is a flow diagram illustrating example operations for codebook determination, in accordance with certain aspects of the present disclosure.

FIG. 5 illustrates example operations for digital predistortion (DPD) training, in accordance with certain aspects of the present disclosure.

FIGS. 6, 7, and 8 are flow diagrams illustrating example operations for wireless communications, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Certain aspects of the present disclosure are directed toward techniques for performing digital predistortion (DPD) training for adaptive beam weights. When using adaptive beam weights, the total number of possible beam weights may be large and depend on the utilized phase and amplitude control precisions, making it challenging to have predetermined and stored DPD coefficients for the beam weights. Some aspects of the present disclosure are directed towards an online DPD training technique where DPD coefficients may be identified for a subset of beam weights. The DPD coefficients for the subset of beam weights may be used to identify, by projection, the DPD coefficients for actual beam weights (e.g., determined as part of adaptive beamforming) used for transmission. For example, a first device may indicate, to a base station, when an adaptive beam weight feature is to be activated. The base station may facilitate the online DPD training process by, for example, pairing the first device with a second device to provide feedback signaling. That is, the first device may transmit training signals using the subset of beam weights and receive feedback signaling that is used to identify the DPD coefficients, as described in more detail herein.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

As used herein, the term “connected with” in the various tenses of the verb “connect” may mean that element A is directly connected to element B or that other elements may be connected between elements A and B (i.e., that element A is indirectly connected with element B). In the case of electrical components, the term “connected with” may also be used herein to mean that a wire, trace, or other electrically conductive material is used to electrically connect elements A and B (and any components electrically connected therebetween).

### An Example Wireless System

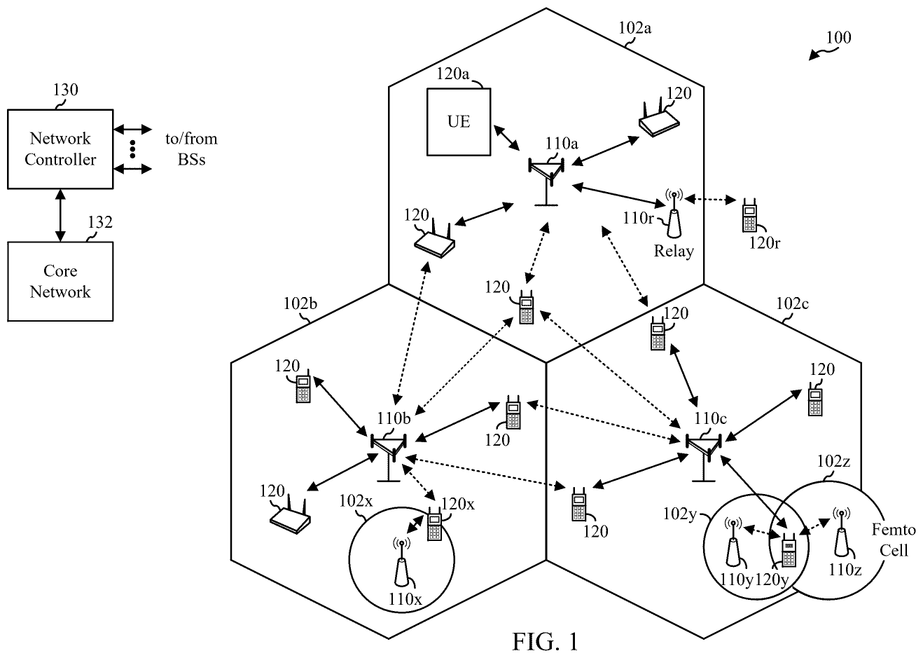

FIG. 1 illustrates an example wireless communications network 100, in which aspects of the present disclosure may be practiced. For example, the wireless communications network 100 may be a New Radio (NR) system (e.g., a Fifth Generation (5G) NR network), an Evolved Universal Terrestrial Radio Access (E-UTRA) system (e.g., a Fourth Generation (4G) network), a Universal Mobile Telecommunications System (UMTS) (e.g., a Second Generation/Third Generation (2G/3G) network), or a code division multiple access (CDMA) system (e.g., a 2G/3G network), or may be configured for communications according to an IEEE standard such as one or more of the 802.11 standards, etc.

As illustrated in FIG. 1, the wireless communications network 100 may include a number of base stations (BSs) 110a-z (each also individually referred to herein as “BS 110” or collectively as “BSs 110”) and other network entities. A BS may also be referred to as an access point (AP), an evolved Node B (eNodeB or eNB), a next generation Node B (gNodeB or gNB), or some other terminology.

A BS 110 may provide communication coverage for a particular geographic area, sometimes referred to as a “cell,” which may be stationary or may move according to the location of a mobile BS. In some examples, the BSs 110 may be interconnected to one another and/or to one or more other BSs or network nodes (not shown) in wireless communications network 100 through various types of backhaul interfaces (e.g., a direct physical connection, a wireless connection, a virtual network, or the like) using any suitable transport network. In the example shown in FIG. 1, the BSs 110a, 110b, and 110c may be macro BSs for the macro cells 102a, 102b, and 102c, respectively. The BS 110x may be a pico BS for a pico cell 102x. The BSs 110y and 110z may be femto BSs for the femto cells 102y and 102z, respectively. A BS may support one or multiple cells.

The BSs 110 communicate with one or more user equipment's (UEs) 120a-y (each also individually referred to herein as “UE 120” or collectively as “UEs 120”) in the wireless communications network 100. A UE may be fixed or mobile and may also be referred to as a user terminal (UT), a mobile station (MS), an access terminal, a station (STA), a client, a wireless device, a mobile device, or some other terminology. A user terminal may be a wireless device, such as a cellular phone, a smartphone, a personal digital assistant (PDA), a handheld device, a wearable device, a wireless modem, a laptop computer, a tablet, a personal computer, etc.

The BSs 110 are considered transmitting entities for the downlink and receiving entities for the uplink. The UEs 120 are considered transmitting entities for the uplink and receiving entities for the downlink. As used herein, a “transmitting entity” is an independently operated apparatus or device capable of transmitting data via a frequency channel, and a “receiving entity” is an independently operated apparatus or device capable of receiving data via a frequency channel. In the following description, the subscript “dn” denotes the downlink, the subscript “up” denotes the uplink. Nᵤₚ UEs may be selected for simultaneous transmission on the uplink, N_{dn} UEs may be selected for simultaneous transmission on the downlink. Nᵤₚ may or may not be equal to N_{dn}, and Nᵤₚ and N_{dn} may be static values or can change for each scheduling interval. Beam-steering or some other spatial processing technique may be used at the BSs 110 and/or UEs 120.

The UEs 120 (e.g., 120x, 120y, etc.) may be dispersed throughout the wireless communications network 100, and each UE 120 may be stationary or mobile. The wireless communications network 100 may also include relay stations (e.g., relay station 110r), also referred to as relays or the like, that receive a transmission of data and/or other information from an upstream station (e.g., a BS 110a or a UE 120r) and send a transmission of the data and/or other information to a downstream station (e.g., a UE 120 or a BS 110), or that relays transmissions between UEs 120, to facilitate communication between devices.

The BSs 110 may communicate with one or more UEs 120 at any given moment on the downlink and uplink. The downlink (i.e., forward link) is the communication link from the BSs 110 to the UEs 120, and the uplink (i.e., reverse link) is the communication link from the UEs 120 to the BSs 110. A UE 120 may also communicate peer-to-peer with another UE 120.

The wireless communications network 100 may use multiple transmit and multiple receive antennas for data transmission on the downlink and uplink. BSs 110 may be equipped with a number Nap of antennas to achieve transmit diversity for downlink transmissions and/or receive diversity for uplink transmissions. A set Nu of UEs 120 may receive downlink transmissions and transmit uplink transmissions. Each UE 120 may transmit user-specific data to and/or receive user-specific data from the BSs 110. In general, each UE 120 may be equipped with one or multiple antennas. The Nu UEs 120 can have the same or different numbers of antennas.

The wireless communications network 100 may be a time division duplex (TDD) system or a frequency division duplex (FDD) system. For a TDD system, the downlink and uplink share the same frequency band. For an FDD system, the downlink and uplink use different frequency bands. The wireless communications network 100 may also utilize a single carrier or multiple carriers for transmission. Each UE 120 may be equipped with a single antenna (e.g., to keep costs down) or multiple antennas (e.g., where the additional cost can be supported).

A network controller 130 (also sometimes referred to as a “system controller”) may be in communication with a set of BSs 110 and provide coordination and control for these BSs 110 (e.g., via a backhaul). In certain cases (e.g., in a 5G NR system), the network controller 130 may include a centralized unit (CU) and/or a distributed unit (DU). In certain aspects, the network controller 130 may be in communication with a core network 132 (e.g., a 5G Core Network (5GC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc.

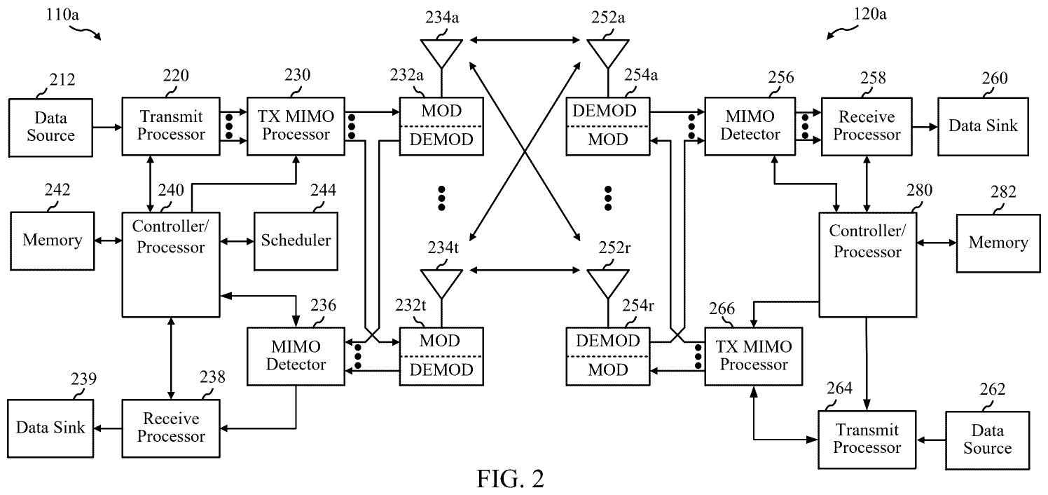

FIG. 2 illustrates example components of BS 110a and UE 120a (e.g., from the wireless communications network 100 of FIG. 1), in which aspects of the present disclosure may be implemented.

On the downlink, at the BS 110a, a transmit processor 220 may receive data from a data source 212, control information from a controller/processor 240, and/or possibly other data (e.g., from a scheduler 244). The various types of data may be sent on different transport channels. For example, the control information may be designated for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), etc. The data may be designated for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a PDSCH, a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), PBCH demodulation reference signal (DMRS), and channel state information reference signal (CSI-RS).

A transmit (TX) multiple-input, multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for orthogonal frequency division multiplexing (OFDM), etc.) to obtain an output sample stream. Each of the transceivers 232a-232t may further process (e.g., convert to analog, amplify, filter, and upconvert) the output sample stream to obtain a downlink signal. Downlink signals from the transceivers 232a-232t may be transmitted via the antennas 234a-234t, respectively.

At the UE 120a, the antennas 252a-252r may receive the downlink signals from the BS 110a and may provide received signals to the transceivers 254a-254r, respectively. The transceivers 254a-254r may condition (e.g., filter, amplify, downconvert, and digitize) a respective received signal to obtain input samples. Each demodulator (DEMOD) in the transceivers 232a-232t may further process the input samples (e.g., for OFDM, etc.) to obtain received symbols. A MIMO detector 256 may obtain received symbols from all the demodulators in transceivers 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH)) from the controller/processor 280. The transmit processor 264 may also generate reference symbols for a reference signal (e.g., the sounding reference signal (SRS)). The symbols from the transmit processor 264 may be precoded by a TX MIMO processor 266 if applicable, further processed by the modulators (MODs) in transceivers 254a-254r (e.g., for single-carrier frequency division multiplexing (SC-FDM), etc.), and transmitted to the BS 110a. At the BS 110a, the uplink signals from the UE 120a may be received by the antennas 234, processed by the demodulators in transceivers 232a-232t, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. The memories 242 and 282 may also interface with the controllers/processors 240 and 280, respectively. A scheduler 244 may schedule UEs for data transmission on the downlink and/or uplink.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The system bandwidth may also be partitioned into subbands. For example, a subband may cover multiple resource blocks (RBs).

### Example RF Transceiver

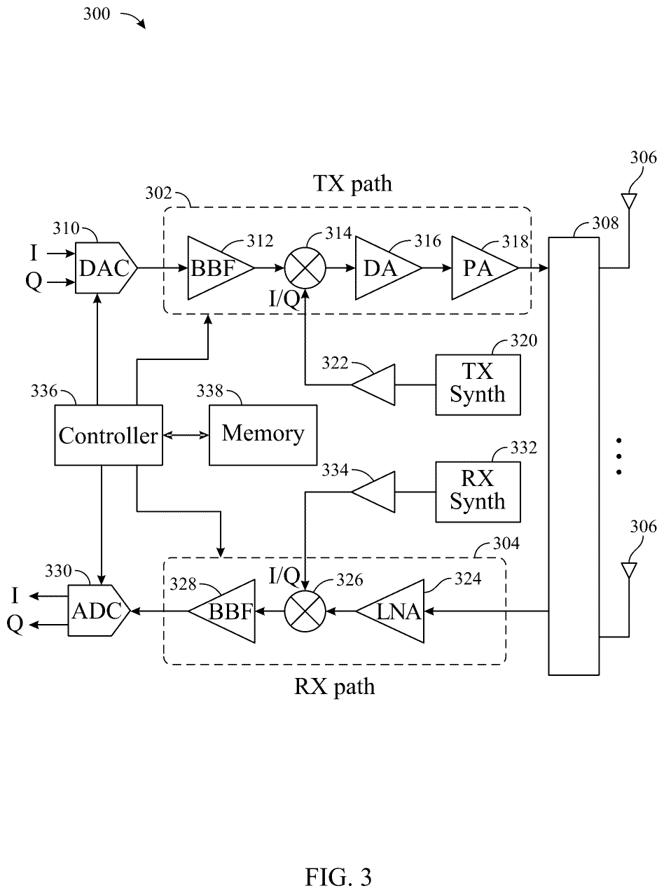

FIG. 3 is a block diagram of an example radio frequency (RF) transceiver circuit 300, in accordance with certain aspects of the present disclosure. The RF transceiver circuit 300 includes at least one transmit (TX) path 302 (also known as a “transmit chain”) for transmitting signals via one or more antennas 306 and at least one receive (RX) path 304 (also known as a “receive chain”) for receiving signals via the antennas 306. When the TX path 302 and the RX path 304 share an antenna 306, the paths may be connected with the antenna via an interface 308, which may include any of various suitable RF devices, such as a switch, a duplexer, a diplexer, a multiplexer, and the like.

Receiving in-phase (I) and/or quadrature (Q) baseband analog signals from a digital-to-analog converter (DAC) 310, the TX path 302 may include a baseband filter (BBF) 312, a mixer 314, a driver amplifier (DA) 316, and a power amplifier (PA) 318. The BBF 312, the mixer 314, the DA 316, and the PA 318 may be included in a radio frequency integrated circuit (RFIC) chip. For certain aspects, the PA 318 may be external to the RFIC chip.

The BBF 312 filters the baseband signals received from the DAC 310, and the mixer 314 mixes the filtered baseband signals with a transmit local oscillator (LO) signal to convert the baseband signal of interest to a different frequency (e.g., upconvert from baseband to a radio frequency). This frequency-conversion process produces the sum and difference frequencies between the LO frequency and the frequencies of the baseband signal of interest. The sum and difference frequencies are referred to as the “beat frequencies.” The beat frequencies are typically in the RF range, such that the signals output by the mixer 314 are typically RF signals, which may be amplified by the DA 316 and/or by the PA 318 before transmission by the antenna(s) 306. In some aspects, a non-linearity associated with the PA 318 may be detected for predictive thermal management, as described in more detail herein. While one mixer 314 is illustrated, several mixers may be used to upconvert the filtered baseband signals to one or more intermediate frequencies and to thereafter upconvert the intermediate frequency (IF) signals to a frequency for transmission.

The RX path 304 may include a low noise amplifier (LNA) 324, a mixer 326, and a baseband filter (BBF) 328. The LNA 324, the mixer 326, and the BBF 328 may be included in one or more RFIC chips, which may or may not be the same RFIC chip that includes the TX path components. RF signals received via the antenna(s) 306 may be amplified by the LNA 324, and the mixer 326 mixes the amplified RF signals with a receive local oscillator (LO) signal to convert the RF signal of interest to a different baseband frequency (e.g., downconvert). The baseband signals output by the mixer 326 may be filtered by the BBF 328 before being converted by an analog-to-digital converter (ADC) 330 to digital I and/or Q signals for digital signal processing.

Certain transceivers may employ frequency synthesizers with a variable-frequency oscillator (e.g., a voltage-controlled oscillator (VCO) or a digitally controlled oscillator (DCO)) to generate a stable, tunable LO with a particular tuning range. Thus, the transmit LO may be produced by a TX frequency synthesizer 320, which may be buffered or amplified by amplifier 322 before being mixed with the baseband signals in the mixer 314. Similarly, the receive LO may be produced by an RX frequency synthesizer 332, which may be buffered or amplified by amplifier 334 before being mixed with the RF signals in the mixer 326. For certain aspects, a single frequency synthesizer may be used for both the TX path 302 and the RX path 304. In certain aspects, the TX frequency synthesizer 320 and/or RX frequency synthesizer 332 may include a frequency divider/multiplier that is driven by an oscillator (e.g., a VCO) in the frequency synthesizer.

A controller 336 (e.g., controller/processor 280 in FIG. 2) may direct the operation of the RF transceiver circuit 300A, such as transmitting signals via the TX path 302 and/or receiving signals via the RX path 304. The controller 336 may be a processor, a digital signal processor (DSP), an application-specific integrated circuit (ASIC), a field-programmable gate array (FPGA) or other programmable logic device (PLD), discrete gate or transistor logic, discrete hardware components, or any combination thereof. A memory 338 (e.g., memory 282 in FIG. 2) may store data and/or program codes for operating the RF transceiver circuit 300. The controller 336 and/or the memory 338 may include control logic (e.g., complementary metal-oxide-semiconductor (CMOS) logic).

While FIGS. 1-3 provide wireless communications as an example application in which certain aspects of the present disclosure may be implemented to facilitate understanding, certain aspects described herein may be used for any of various other suitable systems.

### Techniques for Digital Predistortion (DPD) Training

Adaptive beam weights may be used in hybrid beamforming systems to enable the co-phasing of energy across multiple independent clusters in a channel or across a cluster with a wide angular spread. These clusters correspond to independent propagation paths from the transmitter node to the receiver node. Adaptive beam weights may also address user-equipment (UE) housing-induced mismatches/imbalances across polarizations as well as blockage distortions in electric (E) fields across polarizations. Adaptive beam weights may be learned over synchronization signal blocks (SSBs)/reference signals (RSs) granted to the UE (e.g., channel state information (CSI)-RSs/sounding reference signals (SRSs)) by a base station (e.g., gNB).

Adaptive beam weights can be viewed as non-codebook-based beamforming in contrast to codebook-based beamforming systems where certain direction-based energy steering beam weights are pre-designed and stored in memory for steering energy in a fixed direction. One difference between codebook-based beamforming and adaptive beam weights is that a specific set of beam weights are used at the UE side in codebook-based beamforming. The UE may estimate the reference signal received power (RSRP)/signal strength associated with a beam weight. If the RSRP/signal strength is good (e.g., is above a threshold), the UE may use that beam weight for transmission (Tx)/reception (Rx) (e.g., with some adjustments for uplink (UL)-downlink (DL) circuit mismatches via a calibration operation). In other words, for codebook-based beamforming, the measured beam weights may be the beam weights that are used for data communications. In adaptive beam weights-based beamforming, a set of sampling beams may be used to estimate a channel impulse response (CIR) and used to provide adaptive beams or perform phase/amplitude improvements. From the measurements with the sampling beams, a set of adaptive beam weights may be determined, which may be used for Tx/Rx.

Digital pre-distortion (DPD) is an important feature of wireless devices to increase the effective linearity associated with a power amplifier (PA), especially in premium-tier modems. Certain aspects are directed towards techniques for performing DPD efficiently when an adaptive beam weight feature is used. Certain aspects use two-way signaling and training to implement online DPD. In some aspects, a smaller set of adaptive beam weights for which DPD training is performed may be assumed, from which DPD is performed for the Tx beam of interest, as described in more detail herein.

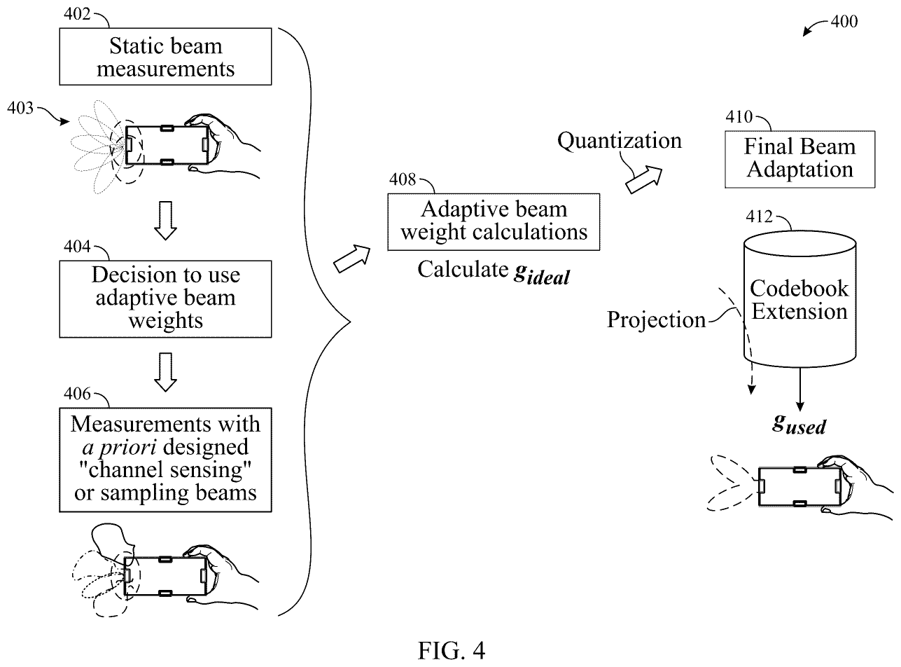

FIG. 4 is a flow diagram illustrating example operations 400 for codebook determination, in accordance with certain aspects of the present disclosure. The operations 400 may be performed, for example, by a device such as a user equipment (UE).

At block 402, the RX device may perform a static beam measurement. For example, the RX device may perform measurements of beams 403. At block 404, the device may decide to use adaptive beam weights (e.g., to improve communication efficiency). At block 406, the device may perform measurements with pre-designed (e.g., a priori-designed) channel sensing or sampling beams, as shown. At block 408, the RX device may calculate adaptive beam weight (e.g., labeled “g_{ideal}”). In some cases, at block 410, the RX may perform quantization of g_{ideal} for final beam adaptation. The calculated beam weight may be associated with one of the pre-stored codebook extensions in database 412 using projection operations, which may be associated with beam weights labeled “g_{used}” for communication, as shown.

Digital pre-distortion (DPD) can be used to handle PA non-linearity within a dynamic range (e.g., a range below saturation power (Pₛₐₜ) of the PA). Non-linearity may be addressed using a filtering operation that is captured (e.g., configured) using DPD coefficients. DPD coefficients may be a function of the beam weights used. A beam weight may indicate the amplitude and phase of the excitations for antenna elements to transmit or receive using a particular beam. Using DPD coefficients where the train beam for transmission is the same as the test beam may provide the best outcome (e.g., communication quality), but comes with high overhead and cost. In some aspects, DPD coefficient learning may be performed with a random set of training beams to reduce overhead, providing a better outcome (e.g., in terms of key performance indicators such as error vector magnitude (EVM)). In the case of a fixed set of beam weights stored in a radio frequency (RF) integrated circuit (RFIC) chip memory, the memory usage may be smaller. Thus, all the codebook-based beam weights may be stored in the RFIC chip memory and studied (e.g., in a factory setting) to identify the corresponding DPD coefficients.

On the other hand, the space of adaptive beam weights may use a large amount of memory. For example, with a B-bit phase shifter and N antenna elements (e.g., B and N being positive integers), there may be (2^{B})^{N-1} phase-based adaptive beam weights. With a B-bit phase shifter and B₁ bits for amplitude control, there may be (2^{B})^{N-1}×(2^{B}₁)^{N} phase and amplitude-based beam weights. For instance, assume B is equal to 3, B₁ is equal to 3, and N is equal to 5; there may be 4096 phase-based weights and 1.3×10⁸ phase and amplitude-based beam weights.

As described, DPD may be beam-dependent, but the space of adaptive beam weights may be large, rendering factory-based DPD difficult. Some aspects are directed towards new capability signaling facilitating an online DPD training process. For example, a device using DPD may indicate to the network that the device is turning on (e.g., activating) the adaptive beam weight feature. A device may not always use adaptive beam weights on uplink (UL). Even if the adaptive beam weight feature is turned on, a device may use only phase-based adaptive beam weights so that there is no loss in equivalent isotropic radiated power (EIRP) due to the use of amplitude control. Devices may use only a subset of antenna elements and a subset of PAs depending on energy savings specifications.

In some aspects, a TX device may be paired with an RX device, where the RX device assists the TX device in learning DPD coefficients (e.g., contingent on the use of adaptive beam weights for beamforming). For example, the TX device may share PA non-linearity features with the RX device to allow the RX device to identify DPD coefficients based on training signals from the RX device. The DPD coefficients may be fed back to the TX device. The PA non-linearity features may include, for example, the saturation power of the PAs (denoted as Pₛₐₜ), or the 1 dB compression point (P_{1 dB}) of the PAs, as a few examples.

The TX device may consider a subset of adaptive beam weights (e.g., as a training set) for online DPD training. The TX device may receive feedback from the RX device for each beam in the training set. The RX device may estimate the DPD coefficients for each adaptive beam weight in the training set using the PA non-linearity features and feed the DPD coefficients back to the TX device, allowing the TX device to perform DPD using the coefficients.

In some aspects, the RX device may provide the raw received data to the TX device, allowing the TX device to estimate the DPD coefficients. The shared data fed back to the TX device may be the raw received signal, channel impulse response (CIR) in a delay-Doppler domain, received signal over subcarriers in a bandwidth part (BWP), or reference signal received power (RSRP). Feeding back the DPD coefficients may lead to less feedback overhead, but may be more intrusive as the PA non-linearity features may be shared with the RX device to perform the DPD coefficient estimation. The subset of adaptive beam weights chosen for DPD training may be (significantly) smaller than the set of all possible adaptive beam weights. The greater the number of adaptive beam weights used for DPD training, the better the performance, but resulting in greater online training overhead.

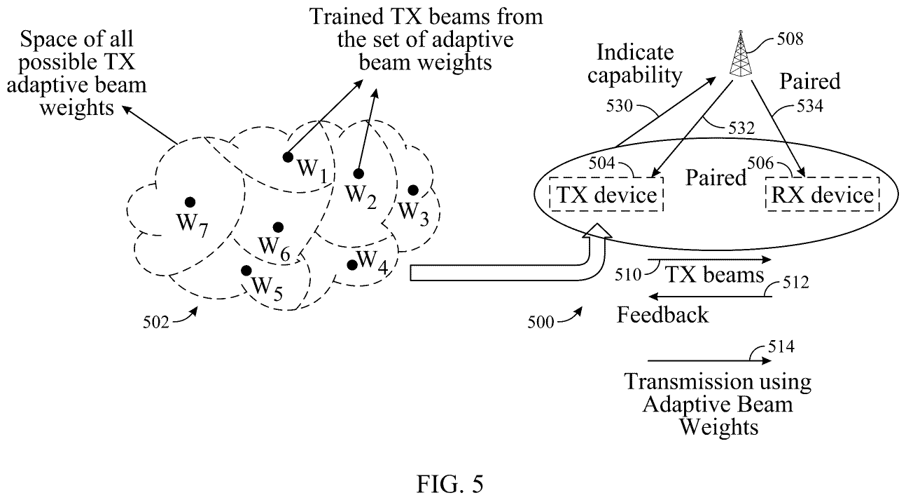

FIG. 5 illustrates example operations 500 for DPD training, in accordance with certain aspects of the present disclosure. The diagram 502 represents all possible TX adaptive beam weights. A TX device 504 may select a subset of beam weights from the possible adaptive beam weights. The subset of beam weights may be weights labeled “w₁” to “w₇” as shown. The TX device 504 may perform DPD training for the subset of beam weights. For any other beam weight used for transmission, the TX device 504 may determine the associated DPD coefficients based on (e.g., using projection operation) the DPD coefficients identified for the subset of beam weights.

As shown, the TX device may indicate a capability 530 to a base station 508. For instance, the TX device may indicate to the base station 508 that the TX device 504 is turning on (e.g., activating) an adaptive beam weight feature. In response, the base station 508 may pair the TX device 504 with an RX device 506 to assist in DPD training. The base station may send an indication 532, to the TX device, that identifies the RX device with which the TX device is paired. The base station may also send an indication 534, to the RX device, identifying the TX device with which the RX device is paired. In some cases, instead of pairing the TX device with an RX device for DPD training, the base station itself may assist the RX device in DPD training.

The TX device may then transmit training signals 510 including TX beams to the RX device (or to the base station) for DPD training. The RX device 506 may determine the DPD coefficients and provide feedback 512 to the TX device 504, which may include the DPD coefficients. In some cases, the RX device 506 may receive, either from the TX device 504 or through the base station 508, PA non-linearity features that allow the RX device to determine the DPD coefficients.

In some cases, instead of determining and feeding back the DPD coefficients, an indication of the received training signals 510 may be fed back, such as the raw training signals as received or a CIR associated with the training signals. Based on the indication of the received training signals 510, the TX device 504 may determine the DPD coefficients for the subset of adaptive beam weights. Based on the DPD coefficients determined for the subset of beam weights (e.g., weights w₁ to w₇), TX device 504 may then determine DPD coefficients for beam weights to be used for transmission 514. The TX device may apply the estimated DPD coefficients to the adaptive beam in TX mode. The DPD coefficients used correspond to the closest adaptive beam for which DPD training has been performed. For instance, the closest adaptive beam wᵢ* may be determined per the equation:

$${w}_{i} *= arg {min}_{wi} {cos}^{- 1} ( \vert {w}^{H} {w}_{i} \vert )$$

where wᵢ are the trained beams and wᵢ* is the beam to be used for TX, w is the un-quantized adaptive beam weight to be used where the distance between beamforming vectors may be minimized (or at least reduced).

Adaptive beam weights are likely to be used for transmissions in the next-generation chipsets. DPD is an important component of premium tier features. Certain aspects have provided techniques in which capability for DPD with adaptive beam weights is indicated and DPD is performed for adaptive beam weights.

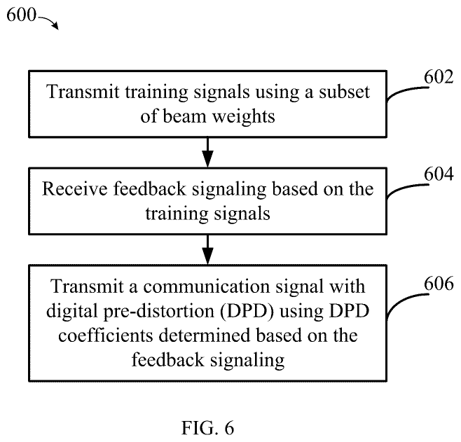

FIG. 6 is a flow diagram illustrating example operations 600 for wireless communications. The operations may be performed by a first device, such as the TX device 504 of FIG. 5.

At block 602, the first device transmits training signals using a subset of beam weights. In some aspects, the subset of beam weights is selected from a set of beam weights available for adaptive beamforming.

At block 604, the first device receives feedback signaling based on the training signals. At block 606, the first device transmits a communication signal with digital pre-distortion (DPD) using DPD coefficients determined based on the feedback signaling.

In some aspects, the feedback signaling includes the DPD coefficients. In this case, the first device may transmit an indication of amplifier non-linearity features of the first device to a second device. The feedback signaling may be received from the second device that determined the DPD coefficients using the amplifier non-linearity features.

In some aspects, the feedback signaling includes an indication of the training signals as received by a second device (e.g., RX device 506 or the base station 508). For example, the indication of the training signals as received may include at least one of: raw data associated with the training signals as received; a channel impulse response (CIR) associated with the training signals as received; data associated with the training signals as received over one or more subcarriers in a bandwidth part (BWP); or a reference signal received power (RSRP) associated with the training signals as received.

In some aspects, the first device may transmit, to a base station, an indication that the first device is activating an adaptive beam weight feature of the first device. The training signals may be transmitted after transmitting the indication. In some aspects, the first device may receive, from the base station, an indication of a second device (e.g., RX device 506) to facilitate DPD training in response to the indication. The training signals may be transmitted to the second device.

In some aspects, transmitting the communication signal may include generating a digital signal based on the DPD coefficients, generating, via a digital-to-analog converter (DAC) (e.g., via DAC 310 of FIG. 3), an analog signal based on the digital signal, and generate, via a power amplifier (e.g., PA 318), an amplified signal for transmission based on the analog signal.

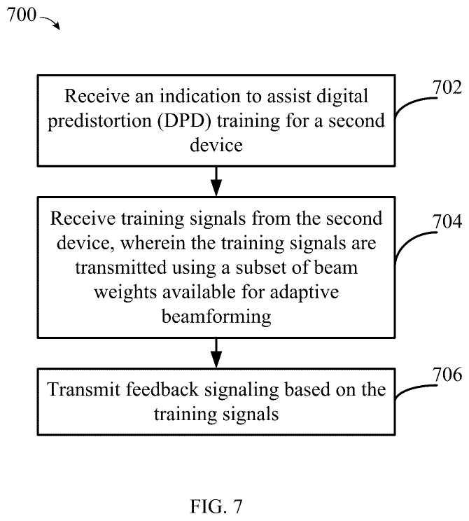

FIG. 7 is a flow diagram illustrating example operations 700 for wireless communications. The operations 700 may be performed by a first device, such as the RX device 506 of FIG. 5.

At block 702, the first device may receive an indication to assist digital predistortion (DPD) training for a second device. At block 704, the first device may receive training signals from the second device. The training signals may be transmitted using a subset of beam weights available for adaptive beamforming.

At block 706, the first device may transmit feedback signaling based on the training signals. In some aspects, the feedback signaling may include DPD coefficients determined based on the training signals. In some aspects, the first device may receive an indication of amplifier non-linearity features of the second device. The DPD coefficients may be determined based on the amplifier non-linearity features.

In some aspects, the feedback signaling may include an indication of the training signals as received by the first device. In some aspects, the indication of the training signals as received may include at least one of: raw data associated with the training signals as received; a channel impulse response (CIR) associated with the training signals as received; data associated with the trainings signals as received over one or more subcarriers in a bandwidth part (BWP); or a reference signal receive power (RSRP) associated with the training signals as received.

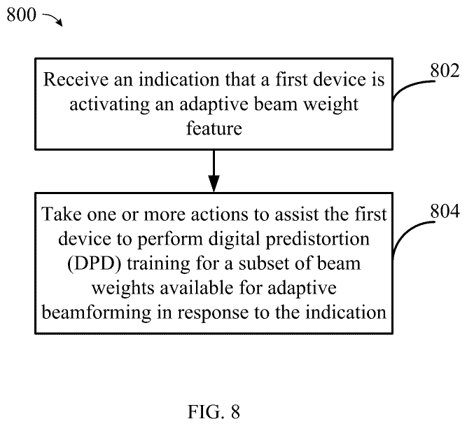

FIG. 8 is a flow diagram illustrating example operations 800 for wireless communications. The operations 700 may be performed by a base station, such as the base station 508 of FIG. 5.

At block 802, the base station may receive an indication that a first device (e.g., TX device 504) is activating an adaptive beam weight feature. At block 804, the base station may take one or more actions to assist the first device to perform DPD training for a subset of beam weights available for adaptive beamforming in response to the indication. In some aspects, the base station may receive a communication signal transmitted with DPD using DPD coefficients identified using the DPD training.

In some aspects, the one or more actions may include identifying a second device to assist the first device to perform the DPD training. In some aspects, the one or more actions may include receiving training signals from the first device, wherein the training signals are transmitted using the subset of beam weights available for the adaptive beamforming, and transmitting, to the first device, feedback signaling based on the training signals. The feedback signaling may include DPD coefficients determined based on the training signals. In some aspects, the base station may receive an indication of amplifier non-linearity features of the first device. The DPD coefficients may be determined based on the amplifier non-linearity features. In some aspects, the feedback signaling includes an indication of the training signals as received by the base station.

### Example Aspects

In addition to the various aspects described above, specific combinations of aspects are within the scope of the present disclosure, some of which are detailed below:
Aspect 1: A method for wireless communications at a first device, comprising: transmitting training signals using a subset of beam weights; receiving feedback signaling based on the training signals; and transmitting a communication signal with digital pre-distortion (DPD) using DPD coefficients determined based on the feedback signaling.
Aspect 2: The method of Aspect 1, wherein the subset of beam weights is selected from a set of beam weights available for adaptive beamforming.
Aspect 3: The method of Aspect 1 or 2, wherein the feedback signaling includes the DPD coefficients.
Aspect 4: The method of Aspect 3, further comprising transmitting an indication of amplifier non-linearity features of the first device to a second device, wherein the feedback signaling is received from the second device that determined the DPD coefficients using the amplifier non-linearity features.
Aspect 5: The method according to any of Aspects 1-4, wherein the feedback signaling includes an indication of the training signals as received by a second device.
Aspect 6: The method of Aspect 5, wherein the indication of the training signals as received comprises at least one of: raw data associated with the training signals as received; a channel impulse response (CIR) associated with the training signals as received; data associated with the training signals as received over one or more subcarriers in a bandwidth part (BWP); or a reference signal received power (RSRP) associated with the training signals as received.
Aspect 7: The method according to any of Aspects 1-6, further comprising transmitting, to a base station, an indication that the first device is activating an adaptive beam weight feature of the first device, wherein the training signals are transmitted after transmitting the indication.
Aspect 8: The method of Aspect 7, further comprising receiving, from the base station, an indication of a second device to facilitate DPD training in response to the indication, wherein the training signals are transmitted to the second device.
Aspect 9: The method according to any of Aspects 1-8, wherein transmitting the communication signal comprises: generating a digital signal based on the DPD coefficients; generating, via a digital-to-analog converter (DAC), an analog signal based on the digital signal; and generating, via power amplifier, an amplified signal for transmission based on the analog signal.
Aspect 10: A method for wireless communications at a first device, comprising: receiving an indication to assist digital predistortion (DPD) training for a second device; receiving training signals from the second device, wherein the training signals are transmitted using a subset of beam weights available for adaptive beamforming; and transmitting feedback signaling based on the training signals.
Aspect 11: The method of Aspect 10, wherein the feedback signaling includes DPD coefficients determined based on the training signals.
Aspect 12: The method of Aspect 11, further comprising receiving an indication of amplifier non-linearity features of the second device, wherein the DPD coefficients are determined based on the amplifier non-linearity features.
Aspect 13: The method according to any of Aspects 10-12, wherein the feedback signaling includes an indication of the training signals as received by the first device.
Aspect 14: A method for wireless communications at a base station, comprising: receiving an indication that a first device is activating an adaptive beam weight feature; and taking one or more actions to assist the first device to perform digital predistortion (DPD) training for a subset of beam weights available for adaptive beamforming in response to the indication.
Aspect 15: The method of Aspect 14, wherein the one or more actions include identifying a second device to assist the first device to perform the DPD training.
Aspect 16: The method of Aspect 14 or 15, further comprising: receiving training signals from the first device, wherein the training signals are transmitted using the subset of beam weights available for the adaptive beamforming; and transmitting, to the first device, feedback signaling based on the training signals.
Aspect 17: The method of Aspect 16, wherein the feedback signaling includes DPD coefficients determined based on the training signals.
Aspect 18: The method of Aspect 17, further comprising receiving an indication of amplifier non-linearity features of the first device, wherein the DPD coefficients are determined based on the amplifier non-linearity features.
Aspect 19: The method according to any of Aspects 16-18, wherein the feedback signaling includes an indication of the training signals as received by the base station.
Aspect 20: The method according to any of Aspects 14-19, further comprising receiving a communication signal transmitted with DPD using DPD coefficients identified using the DPD training.

The above description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim.

The various operations of methods described above may be performed by any suitable means capable of performing the corresponding functions. The means may include various hardware and/or software component(s) and/or module(s), including, but not limited to a circuit, an application-specific integrated circuit (ASIC), or processor. Generally, where there are operations illustrated in figures, those operations may have corresponding counterpart means-plus-function components.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes, and variations may be made in the arrangement, operation, and details of the methods and apparatus described above without departing from the scope of the claims.

1. A method for wireless communications at a first device, comprising:
transmitting training signals using a subset of beam weights;
receiving feedback signaling based on the training signals; and
transmitting a communication signal with digital pre-distortion (DPD) using DPD coefficients determined based on the feedback signaling.

2. The method of claim 1, wherein the subset of beam weights is selected from a set of beam weights available for adaptive beamforming.

3. The method of claim 1, wherein the feedback signaling includes the DPD coefficients.

4. The method of claim 3, further comprising transmitting an indication of amplifier non-linearity features of the first device to a second device, wherein the feedback signaling is received from the second device that determined the DPD coefficients using the amplifier non-linearity features.

5. The method of claim 1, wherein the feedback signaling includes an indication of the training signals as received by a second device.

6. The method of claim 5, wherein the indication of the training signals as received comprises at least one of:
raw data associated with the training signals as received;
a channel impulse response (CIR) associated with the training signals as received;
data associated with the training signals as received over one or more subcarriers in a bandwidth part (BWP); or
a reference signal received power (RSRP) associated with the training signals as received.

7. The method of claim 1, further comprising transmitting, to a base station, an indication that the first device is activating an adaptive beam weight feature of the first device, wherein the training signals are transmitted after transmitting the indication.

8. The method of claim 7, further comprising receiving, from the base station, an indication of a second device to facilitate DPD training in response to the indication, wherein the training signals are transmitted to the second device.

9. The method of claim 1, wherein transmitting the communication signal comprises:
generating a digital signal based on the DPD coefficients;
generating, via a digital-to-analog converter (DAC), an analog signal based on the digital signal; and
generating, via power amplifier, an amplified signal for transmission based on the analog signal.

10. A method for wireless communications at a first device, comprising:
receiving an indication to assist digital predistortion (DPD) training for a second device;
receiving training signals from the second device, wherein the training signals are transmitted using a subset of beam weights available for adaptive beamforming; and
transmitting feedback signaling based on the training signals.

11. The method of claim 10, wherein the feedback signaling includes DPD coefficients determined based on the training signals.

12. The method of claim 11, further comprising receiving an indication of amplifier non-linearity features of the second device, wherein the DPD coefficients are determined based on the amplifier non-linearity features.

13. The method of claim 10, wherein the feedback signaling includes an indication of the training signals as received by the first device.

14. A method for wireless communications at a base station, comprising:
receiving an indication that a first device is activating an adaptive beam weight feature; and
taking one or more actions to assist the first device to perform digital predistortion (DPD) training for a subset of beam weights available for adaptive beamforming in response to the indication.

15. The method of claim 14, wherein the one or more actions include identifying a second device to assist the first device to perform the DPD training.

16. The method of claim 14, further comprising:
receiving training signals from the first device, wherein the training signals are transmitted using the subset of beam weights available for the adaptive beamforming; and
transmitting, to the first device, feedback signaling based on the training signals.

17. The method of claim 16, wherein the feedback signaling includes DPD coefficients determined based on the training signals.

18. The method of claim 17, further comprising receiving an indication of amplifier non-linearity features of the first device, wherein the DPD coefficients are determined based on the amplifier non-linearity features.

19. The method of claim 16, wherein the feedback signaling includes an indication of the training signals as received by the base station.

20. The method of claim 14, further comprising receiving a communication signal transmitted with DPD using DPD coefficients identified using the DPD training.
